(19) United States
(12) Patent Application Publication
(10) Pub. No.: US 2005/0098250 A1
(43) Pub. Date: May 12, 2005

(54) Tire for rear wheel of motorcycle

(75) Inventor: Mayumi Ito, Kobe-shi (JP)

Correspondence Address: BIRCH STEWART KOLASCH & BIRCH, PO BOX 747, FALLS CHURCH, VA, 22040-0747, US

(73) Assignee: Sumitomo Rubber Industries, Ltd., Kobe-Shi (JP)

(21) Appl. No.: 10/924,779

(22) Filed: Aug. 25, 2004

(30) Foreign Application Priority Data
Nov. 10, 2003 (JP) 2003-380559

(51) Int. Cl. B60C 11/03; B60C 11/13; B60C 11/02; B60C 13/04; B60C 119/00; B60C 123/00

(52) U.S. Cl. 152/209.11; 152/209.23

(57) ABSTRACT

A tire (10) is employed for the rear wheel of a motorcycle. A tread surface (16) is provided with a waveform groove (22), an intermediate groove (23) and a shoulder groove (24). The waveform groove (22) meanders in a circumferential direction over the central portion of the tread surface (16). The intermediate groove (23) is provided on the left and right of the waveform groove (22) along the waveform groove (22). The intermediate groove (23) is present in a predetermined region (ER). The intermediate groove (23) is formed like a boomerang having a long portion (32) and a short portion (31). An angle θ with respect to the axial direction of the long portion (32) is 45 to 75 degrees. The shoulder groove (24) is provided on an outside in the axial direction of the tread surface (16). An angle α of the shoulder groove (24) is set to be 25 degrees≦α≦50 degrees and α<θ.

This application claims priority on Patent Application No. 2003-380559 filed in Japan on Nov. 10, 2003.

### BACKGROUND OF THE INVENTION

1. Field of the Invention

The present invention relates to a tire for a motorcycle. More particularly, the present invention relates to a structure of a tire to be employed for a rear wheel of a motorcycle.

2. Description of the Related Art

When a motorcycle carries out cornering, a driver inclines the attitude of the motorcycle inward in a cornering direction. At this time, a tire comes in contact with a road surface to form a camber angle and generates a camber thrust on the contact surface of the tire. The camber thrust is resistant to a centrifugal force generated in the cornering of the motorcycle. The camber thrust realizes the stable cornering of the motorcycle.

In order to generate the stable camber thrust, the tire is formed to draw a large arch in such a manner that a tread surface is convex in a radial direction. When the motorcycle runs straight, the central part of the tread surface of the tire comes in contact with a ground. When the motorcycle carries out cornering, the edge portion (shoulder portion) of the tread surface of the tire comes in contact with the ground. Accordingly, a load to be applied to the tire is changed complicatedly depending on the running manner of the motorcycle. The tire is required to realize a running stability for both straight running and cornering, and various improvements are made in order to satisfy this requirement.

In a tire for a public road which is generally put on the market, a sound (a noise) generated during running is to be reduced to be equal to or smaller than a constant level. For this reason, particularly, a tread pattern to be formed on a tread surface has been devised in a tire for a rear wheel. This has been described in Japanese Laid-Open Patent Publications Nos. 2000-43509, 11-291715, 11-291716, 10-297218, 10-244811, 7-276921, 6-55909 and 1-204806.

A conventional countermeasure against a noise aims principally at a reduction in a sound generated in the straight running of the motorcycle. For this reason, an effective countermeasure has not been taken against a noise in the cornering of the motorcycle, that is, a noise in a state in which the shoulder portion of a tire comes in contact with a ground. In a conventional tire, accordingly, a silence is maintained in the straight running of the motorcycle. However, there is a problem in that the noise is generated in the cornering. Indeed, such a problem does not adversely influence the safety of the motorcycle. In some cases, however, a driver feels an incompatibility.

### SUMMARY OF THE INVENTION

The present invention has been made in such a background. It is an object of the present invention to provide a tire for a rear wheel of a motorcycle in which a silence is held in cornering while a running stability is maintained for both straight running and cornering. In the following, the tire for a rear wheel of a motorcycle will be referred to as a “tire”.

A tire according to the present invention has a single waveform groove provided in a circumferential direction on a center of a tread surface, and a plurality of intermediate grooves arranged regularly side by side along the waveform groove outward in an axial direction of the waveform groove. Each of the intermediate grooves takes a shape of a boomerang having a short portion extended outward in an axial direction to gradually go away from the waveform groove, and a long portion linked continuously to the short portion and extended inward in the axial direction to gradually approach the waveform groove, and crossing at an angle θ (45 degrees≦θ≦75 degrees) with respect to the axial direction. Each of the intermediate grooves is provided in a region of 0.15 W to 0.6 W on the basis of the center of the tread surface with respect to a tread width W.

In the present invention, the rate of an area occupied by the long portion in the portion (contact surface) of the tread surface which comes in contact with a ground is reduced. The reason is that the intermediate groups are formed like the boomerang respectively and the angle θ of the long portion of each intermediate groove is set to be 45 degrees or more. Accordingly, a great pitch sound can be prevented from being generated when the tire rolls over the ground.

In a transition in which the motorcycle is switched from the straight running to the cornering, that is, in a process in which the portion of the tire coming in contact with the ground is changed from the center of the tread surface to the shoulder portion, the rate of the areas occupied by the long and short portions in the contact surface can be prevented from being changed suddenly. The reason is that the angle θ is set to be 75 degrees or less, and furthermore, each intermediate groove is provided in the region (0.15 W to 0.6 W). Also in the transition in which the motorcycle is switched from the straight running to the cornering, accordingly, a great pitch sound can be prevented from being generated suddenly when the tire rolls over the ground.

A difference in a noise level is not changed greatly between a sound generated when the motorcycle carries out the straight running and a sound generated when the motorcycle carries out the cornering. Moreover, there is an advantage that the generation of TGC (Tread Groove Cracking) is suppressed. The reason is that a waveform groove is provided on the center of the tread surface. The advantage is remarkable in the case in which a band ply constituting the tire particularly has a JLB (joint less band) structure (a structure in which a single and long band cord is wound upon a carcass). More specifically, if a straight groove is provided on the center of the tread surface, the direction of the groove almost overlaps with that of the band cord. Therefore, the portion on which the groove is formed is flexed easily. Accordingly, a distortion is generated repetitively in the portion on which the groove is formed so that the TGC is apt to be generated. On the other hand, the waveform groove is provided so that a continuous groove is not formed in the circumferential direction of the tire. As a result, the generation of the TGC is suppressed.

A plurality of shoulder grooves may be regularly arranged circumferentially side by side outward in the axial direction of the intermediate groove. It is preferable that each of the shoulder grooves should be extended in a direction as that to cross at an angle α (25 degrees≦α≦50 degrees) with respect to the axial direction. The angle α<the angle θ is set.

In the case in which a camber angle is great in the cornering of the motorcycle, that is, the motorcycle carries out high speed cornering, a grip force (particularly, a wet grip force) of the tire is maintained because the shoulder groove is provided. In addition, the shoulder groove is provided in such a manner that the angle is set to be α. Also in the transition in which the motorcycle is switched from the straight running to the cornering, therefore, a great pitch sound can be prevented from being generated suddenly from the tire.

As described above, according to the present invention, the tread pattern is devised. In the straight running and cornering of the motorcycle and their transition, consequently, the noise level of the tire can be reduced and a silence can be maintained irrespective of a running manner.

### BRIEF DESCRIPTION OF THE DRAWINGS

FIG. 1 is a sectional view showing the main part of the structure of a tire according to an embodiment of the present invention,

FIG. 2 is a view seen in an arrow of II in FIG. 1,

FIG. 3 is a sectional view taken along a line III-III in FIG. 2,

FIG. 4 is a sectional view taken along a line IV-IV in FIG. 2,

FIG. 5 is a sectional view taken along a line V-V in FIG. 2,

FIG. 6 is a sectional view taken along a line VI-VI in FIG. 2,

FIG. 7 is a sectional view taken along a line VII-VII in FIG. 2,

FIG. 8 is a sectional view taken along a line VIII-VIII in FIG. 2,

FIG. 9 is a sectional view taken along a line IX-IX in FIG. 2,

FIG. 10 is a sectional view taken along a line X-X in FIG. 2, and

FIG. 11 is a sectional view taken along a line XI-XI in FIG. 2.

### DESCRIPTION OF THE PREFERRED EMBODIMENTS

The present invention will be described below in detail based on a preferred embodiment with reference to the drawings.

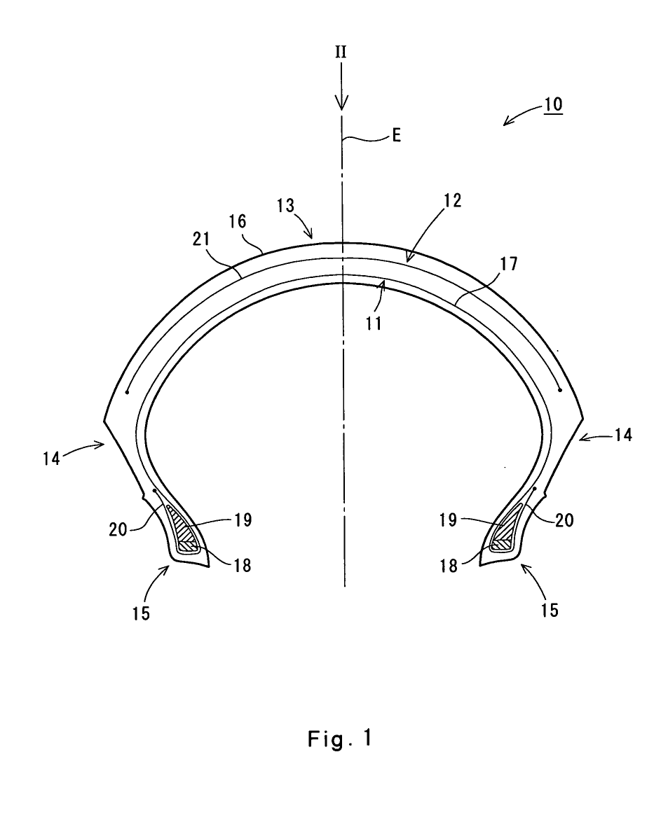

FIG. 1 typically shows the structure of a tire 10 for a motorcycle (hereinafter referred to as a “tire”) according to an embodiment of the present invention. The tire 10 is particularly employed for the rear wheel of the motorcycle. FIG. 1 illustrates a section taken along a plane which passes through the center of the tire 10 and is orthogonal to an equator plane E of the tire 10. In FIG. 1, a vertical direction indicates a radial direction of the tire 10 and a transverse direction indicates an axial direction of the tire 10.

The tire 10 takes a symmetrical shape about the equator plane E. The tire 10 comprises a carcass 11 constituting the frame of the tire 10, a band 12 for reinforcing the carcass 11, a tread 13, a sidewall 14, and a bead 15. The outer peripheral surface of the tread 13 particularly constitutes a tread surface 16.

The tire 10 according to the present embodiment features the structure of a tread pattern formed on the tread surface 16. The tread pattern has a structure which will be described below. In the case in which the tire 10 is attached to the motorcycle, therefore, it is possible to maintain a high silence without damaging a running stability irrespective of the running manner of the motorcycle.

The tread 13 is constituted by a crosslinked rubber. The tread 13 is formed like an arch to be outward convex in a radial direction. When the motorcycle carries out cornering, consequently, a stable camber thrust is generated. As shown in FIG. 1, the tread surface 16 is also formed to draw a large arch. A tread pattern (not shown) having a groove and a land is formed on the tread surface 16. The specific structure of the tread pattern will be described below.

The tread surface 16 comes in contact with a road surface. More specifically, the central part of the tread surface 16 comes in contact with the road surface when the motorcycle carries out straight running, and an outward portion in the radial direction of the tread surface 16, that is, a shoulder portion comes in contact with the road surface when the motorcycle carries out cornering. A portion of the tread surface 16 which comes in contact with the ground will be particularly referred to as a contact surface.

The sidewall 14 is continuously linked to the tread 13 and is extended inward in the radial direction from both ends of the tread 13. The sidewall 14 is also constituted by a crosslinked rubber. The sidewall 14 absorbs a shock from the road surface by a flexure. Moreover, the sidewall 14 prevents the carcass 11 from being externally damaged.

The bead 15 is continuously formed with the sidewall 14. The bead 15 includes a bead core 18 and a bead apex 19 extended outward in a radial direction from the bead core 18. The bead core 18 is formed annularly and is constituted by a plurality of non-extensible wires (typically, wires formed of steel). The bead apex 19 is formed like a taper which is tapered outward in the radial direction, and is formed of a crosslinked rubber.

The carcass 11 is formed integrally with the tread 13, the sidewall 14 and the bead 15. As shown in FIG. 1, the carcass 11 is present as a carcass ply 17 in the tire 10. The carcass ply 17 constitutes the frame of the tire 10. The carcass ply 17 is provided along the inside of the tread 13, the sidewall 14 and the bead 15. The carcass ply 17 has both ends 20 overlaid around the bead core 18. The carcass ply 17 includes a carcass cord. The carcass cord is covered with a topping rubber. A resin such as nylon or rayon is employed for the carcass cord, and a natural rubber, a styrene butadiene rubber, a cis-1•4-polybutadiene synthetic rubber, their mixture or the like is employed for the topping rubber, for example.

The band 12 is formed integrally with the carcass 11, the tread 13 and the like. As shown in FIG. 1, the band 12 is present as a band ply 21 in the tire 10. The band ply 21 covers the carcass ply 17. The band ply 21 has a band cord. The band cord is constituted by a metal cord (a steel cord or the like), an organic fiber cord (an aramid fiber cord or the like) or the like, for example. The band cord is a long and single member. The band cord is wound in the almost circumferential direction of the tire 10. The band cord is wound around the carcass ply 17 so that the carcass ply 17 is fastened. Thus, a predetermined reinforcement is carried out. The structure of the band ply 21 will be referred to as a JLB structure. The band ply 21 is not restricted to such a structure but it may have the same structure as that of the carcass ply 17.

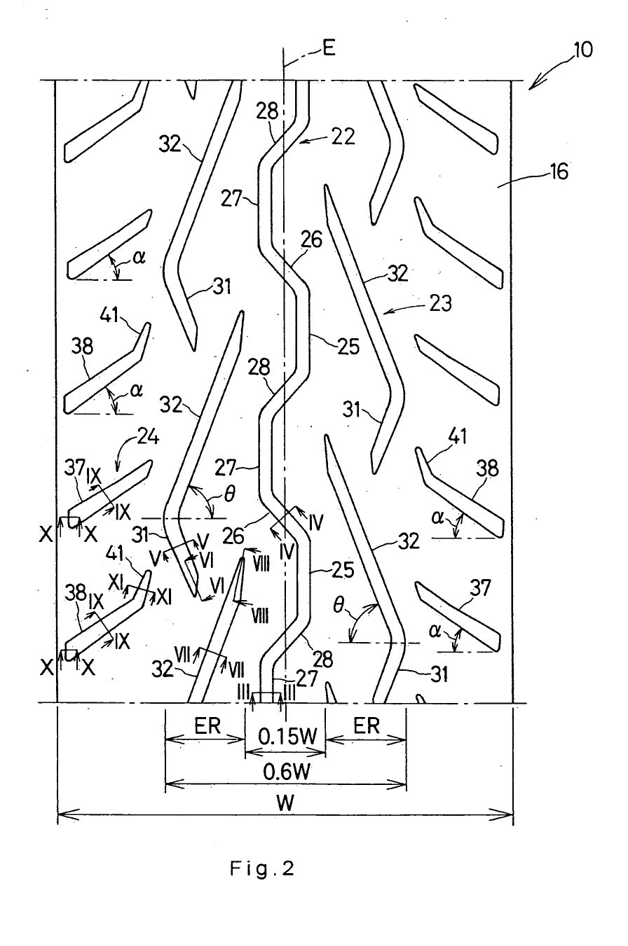

FIG. 2 shows the structure of the main part of the tread surface 16. As shown in FIG. 2, a waveform groove 22, an intermediate groove 23 and a shoulder groove 24 are provided on the tread surface 16.

The waveform groove 22 is provided on the center of the tread surface 16 in the circumferential direction of the tire 10. The waveform groove 22 is formed as a waveform bent transversely in an axial direction around the center of the tread surface 16 (that is, the equator plane E). In FIG. 2, only the main part of the tread surface 16 is shown, and therefore, only a part of the waveform groove 22 is also shown. However, the waveform groove 22 is actually formed circularly along the tread surface 16.

More specifically, the waveform groove 22 includes a straight portion 25, an oblique portion 26, a straight portion 27 and an oblique portion 28. The straight portion 25 is provided straight in a circumferential direction on one side in the axial direction of the equator plane E. The oblique portion 26 is continuously linked to the straight portion 25. The oblique portion 26 is provided obliquely across the equator plane E at the other side in the axial direction. The straight portion 27 is continuously linked to the oblique portion 26. The straight portion 27 is provided straight in the circumferential direction on the other side in the axial direction of the equator plane E. The oblique portion 28 is continuously linked to the straight portion 27. The oblique portion 28 is provided obliquely across the equator plane E at one side in the axial direction. More specifically, the waveform groove 22 is formed in such a manner that each of the portions 25 to 28 is continuously linked in the circumferential direction to meander over the center of the tread surface 16. Moreover, the straight portions 25 and 27 and the oblique portions 26 and 28 are continuously linked smoothly to each other, and the portions in which they are continuously linked to each other are chamfered as shown in FIG. 2.

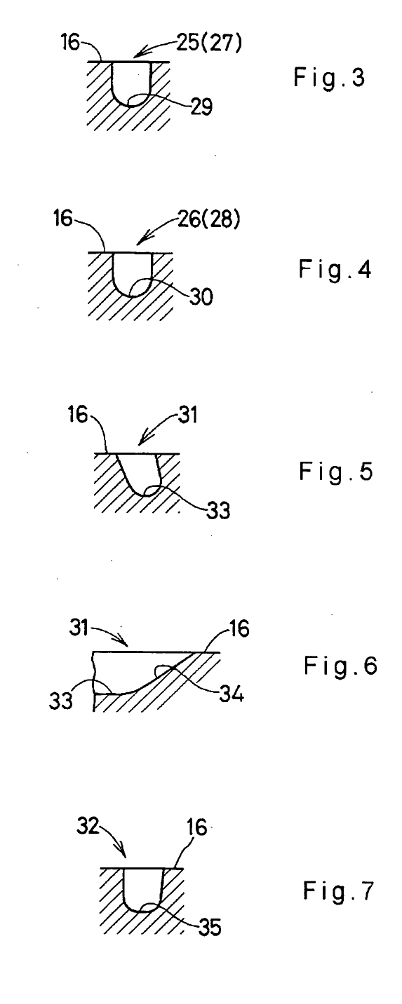

FIG. 3 shows the sectional shapes of the straight portions 25 and 27. As shown in FIG. 3, the internal surface of each of the straight portions 25 and 27 takes an almost U shape. A bottom face 29 of each of the straight portions 25 and 27 is curved arcuately.

FIG. 4 shows the sectional shapes of the oblique portions 26 and 28. As shown in FIG. 4, the internal surface of each of the oblique portions 26 and 28 takes an almost U shape. A bottom face 30 of each of the oblique portions 26 and 28 is curved arcuately. The radius of curvature of the bottom face 30 is set to be smaller than that of the bottom face 29. Indeed, the radii of curvature of the bottom faces 29 and 30 are not particularly restricted. The radii of curvature of the bottom faces 29 and 30 may be equal to each other or the radius of curvature of the bottom face 29 may be set to be smaller than that of the bottom face 30.

The intermediate groove 23 is formed like a boomerang as shown in FIG. 2. The intermediate groove 23 is provided almost symmetrically on one side and the other side in the axial direction around the equator plane E. The intermediate groove 23 is provided uniformly at a predetermined interval in the circumferential direction. In other words, the intermediate grooves 23 are provided on the left and right sides of the waveform groove 22. The intermediate grooves 23 are regularly arranged side by side along the waveform groove 22. The intermediate grooves 23 arranged side by side on one side in the axial direction are provided to make a shift in the circumferential direction by a predetermined distance from the intermediate grooves 23 arranged side by side on the other side in the axial direction. The intermediate grooves 23 provided on one side and the other side in the axial direction are not coupled to each other but overlap with each other by a predetermined dimension in the circumferential direction.

Each of the intermediate grooves 23 includes a short portion 31 and a long portion 32 linked continuously to the short portion 31. The long portion 32 is continuously linked to be bent with respect to the short portion 31. The long portion 32 and the short portion 31 are continuously linked smoothly and a portion in which they are continuously linked to each other is chamfered. The end of the short portion 31 and that of the long portion 32 are formed like a taper. Accordingly, the ends of the short portion 31 and the long portion 32 have widths (dimensions in the axial direction) reduced gradually in the circumferential direction of the tire 10. The short portion 31 is extended outward in the axial direction to gradually go away from the waveform groove 22 and is continuously linked to the long portion 32. The long portion 32 is continuously linked to the short portion 31 and is extended inward in the axial direction to gradually approach the waveform groove 22.

As shown in FIG. 5, the short portion 31 of the intermediate groove 23 is cut in such a direction as to be turned toward the central point of the tire 10. On the central point of the tire 10, a central axis of the tire 10 (a central axis in an axial direction) intersects the equator plane E. A bottom face 33 of the short portion 31 is curved arcuately as shown in FIG. 5. As shown in FIG. 6, the end of the short portion 31 has a depth reduced gradually. More specifically, a wall surface 34 for partitioning the end of the short portion 31 is inclined from the bottom face 33 of the short portion 31 toward the tread surface 16. The wall surface 34 and the bottom face 33 are continuously linked smoothly to each other.

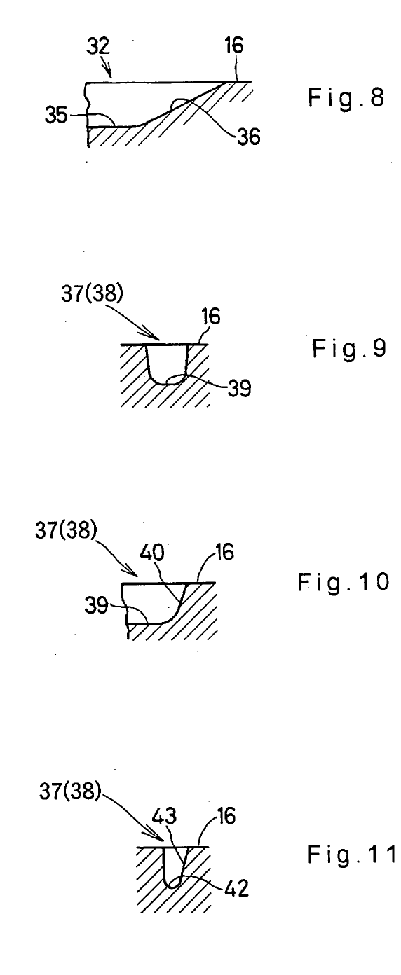

As shown in FIG. 7, the long portion 32 of the intermediate groove 23 is cut in an almost perpendicular direction to the tread surface 16. A bottom face 35 of the long portion 32 has a corner portion curved arcuately and a portion for coupling the corner portions to each other is formed to be a plane as shown in FIG. 7. As shown in FIG. 8, the end of the long portion 32 has a depth reduced gradually. A wall surface 36 for partitioning the end of the long portion 32 is inclined from the bottom face 35 of the long portion 32 toward the tread surface 16. The wall surface 36 and the bottom face 35 are continuously linked smoothly to each other.

As shown in FIG. 2, the long portion 32 of the intermediate groove 23 is provided to form an angle θ with respect to the axial direction. In the present embodiment, the angle θ is set to be 70 degrees. The angle θ is properly set within a range of 45 to 75 degrees.

Each of the intermediate grooves 23 is provided in a constant region ER on the basis of the center of the tread surface 16 with respect to a tread width W of the tire 10. More specifically, the end of the long portion 32 of the intermediate groove 23 is positioned on an outside in the axial direction from 0.15 W on the basis of the center of the tread surface 16. A portion in which the long portion 32 and the short portion 31 are continuously linked to each other is positioned on an inside in the axial direction from 0.6 W on the basis of the center of the tread surface 16. In other words, it is sufficient that the intermediate groove 23 is provided in the region ER on the assumption that the angle θ is set within a range of 45 to 75 degrees.

As shown in FIG. 2, the shoulder groove 24 is provided uniformly at a predetermined interval in the circumferential direction. The shoulder groove 24 is regularly provided in the circumferential direction in the shoulder portion of the tire 10 (that is, an outside in the axial direction of the intermediate groove 23). The shoulder groove 24 includes a plurality of first shoulder grooves 37 and a plurality of second shoulder grooves 38 which are arranged alternately.

The shoulder groove 24 crosses at an angle α with respect to the axial direction. In the present embodiment, the angle α is set to be 35 degrees. The angle α is properly set to be 25 to 50 degrees. The angle α is set to be smaller than the angle θ of the long portion 32 of the intermediate groove 23. The first shoulder groove 37 and the second shoulder groove 38 take almost the same shapes, and the tip portion of the second shoulder groove 38 is bent toward the circumferential side of the tire 10.

As shown in FIG. 9, the shoulder groove 24 is cut in an almost perpendicular direction to the tread surface 16. A bottom face 39 in the central part of the shoulder groove 24 has corner portions curved arcuately, and a portion for coupling the corner portions to each other is formed to be a plane. As shown in FIG. 10, an end on an outer side in the radial direction of the shoulder groove 24 has a depth reduced gradually. More specifically, a wall surface 40 for partitioning the end is inclined from the bottom face 39 toward the tread surface 16. The wall surface 40 and the bottom face 39 are continuously linked smoothly to each other.

FIG. 11 shows the shape of the internal wall surface of a tip portion 41 of the second shoulder groove 38. As shown in FIG. 11, the shape of the internal wall surface of the tip portion 41 is formed to take an almost U shape. A bottom face 42 of the tip portion 41 is formed arcuately. A wall surface 43 on an inside in the axial direction of the tip portion 41 is inclined inward in the axial direction. The wall surface 43 is continuously linked smoothly to the bottom face 42.

In the tire 10 having such a tread pattern formed thereon, the rate of an area occupied by the long portion 32 over the contact surface of the tire 10 is decreased. The reason is that each intermediate groove 23 provided on the tread surface 16 is formed to take the shape described above, and furthermore, the angle θ of the long portion 32 of the intermediate groove 23 is set to be 45 degrees or more (see FIG. 2). In the case in which the motorcycle runs and the tire 10 rolls over a ground, accordingly, a great pitch sound can be prevented from being generated.

In a transition in which the motorcycle is switched from straight running to cornering, that is, a process in which the contact surface is changed from the center of the tread surface 16 of the tire 10 to the shoulder portion, the rate of the area occupied by the intermediate groove 23 in the contact surface can be prevented from being changed suddenly. The reason is that the angle θ of the long portion 32 is set to be 75 degrees or less, and furthermore, the intermediate groove 23 is provided in the region ER. Also in the transition in which the motorcycle is switched from the straight running to the cornering, accordingly, a great pitch sound can be prevented from being generated suddenly when the tire 10 rolls over the ground. If the angle θ is greater than 75 degrees, the direction of the band cord tends to overlap with that of the long portion 32. Consequently, the tread surface 16 is apt to be flexed. As a result, there is a disadvantage that the characteristics of the transition are deteriorated.

A difference in a noise level is not greatly changed between a sound generated when the motorcycle carries out the straight running and a sound generated when the motorcycle carries out the cornering. The reason is that the waveform groove 22 is formed to meander over the center of the tread surface 16. In the case in which the motorcycle is switched from the straight running to the cornering and the case in which the motorcycle is switched from the cornering to the straight running, accordingly, a noise is changed smoothly. By forming the waveform groove 22 to take the shape described above, it is possible to suppress the generation of TGC (Tread Groove Cracking).

In the tire 10 according to the present embodiment, accordingly, the noise level of the tire 10 can be reduced and a great silence can be maintained irrespective of a running manner when the motorcycle carries out the straight running and the cornering and in their transition.

In the tire 10, particularly, the shoulder groove 24 is provided on the outside in the axial direction of the intermediate groove 23. Consequently, a grip force (particularly, a wet grip force) of the tire 10 can be maintained when the motorcycle carries out high speed cornering (a camber angle is great). Furthermore, the shoulder groove 24 is provided to form the angle α with the axial direction over the tread surface 16. In the transition from the straight running to the cornering, therefore, a great pitch sound can be prevented from being suddenly generated from the tire 10.

### EXAMPLES

The effects of the present invention will be apparent below from examples and the present invention should not be construed to be restricted based on the description of the examples.

Table 1 and Table 2 show the performance of a tire according to the examples of the present invention, respectively. These Tables indicate results obtained by executing the comparison tests of the examples (a first comparison test and a second comparison test) with comparative examples.

In the first comparison test, a tire according to each of the examples and the comparative examples has a size of 180/70R16. The tire according to each of the examples and the comparative examples is attached to a predetermined rim (MT5.00×16). The internal pressure of the tire is set to be 225 kPa. A motorcycle (a test vehicle) to be used in the first comparison test is a large-sized vehicle mounting a 4-cycle 1800 cc engine.

In the first comparison test, the tire attached to the rim (the tire according to each of the comparative examples and the examples) is employed for the rear wheel of the test vehicle. In the first comparison test, tire noises in the straight running and the cornering of the test vehicle (a noise feeling in the straight running and a noise feeling in the cornering) are compared with each other. The comparison test is carried out depending on the subjective judgment of the driver of the test vehicle. The driver of the test vehicle evaluates the tire noise into three stages (A, B and C ranks). The A rank represents the most excellent feeling (a small noise). In the first comparison test, the high speed cornering is carried out and a camber angle in the cornering is set to be small (3 to 15 degrees). In the first comparison test, accordingly, the presence of a shoulder groove does not influence the result of the test.

In the second comparison test, the tire attached to the rim (the tire according to each of the comparative examples and the examples) is employed for the rear wheel of the test vehicle. In the second comparison test, tire noises in the cornering of the test vehicle (noise feelings in the cornering) are compared with each other. The comparison test is carried out depending on the subjective judgment of the driver of the test vehicle. The driver of the test vehicle evaluates the tire noise into three stages (A, B and C ranks). The A rank represents the most excellent feeling (a small noise). In the second comparison test, the camber angle in the cornering is set to be great (15 to 35 degrees).

In the first comparison test, the tread pattern of the tire according to each of the examples and the comparative examples is as follows.

### Example 1

A waveform groove, an intermediate groove and a shoulder groove are present on a tread surface. The long portion of the intermediate groove has an angle θ of 45 degrees. The region of the intermediate groove is 0.15 W to 0.6 W.

### Example 2

A waveform groove, an intermediate groove and a shoulder groove are present on a tread surface. The long portion of the intermediate groove has an angle θ of 55 degrees. The region of the intermediate groove is 0.15 W to 0.6 W.

### Example 3

A waveform groove, an intermediate groove and a shoulder groove are present on a tread surface. The long portion of the intermediate groove has an angle θ of 65 degrees. The region of the intermediate groove is 0.15 W to 0.6 W.

### Example 4

A waveform groove, an intermediate groove and a shoulder groove are present on a tread surface. The long portion of the intermediate groove has an angle θ of 75 degrees. The region of the intermediate groove is 0.15 W to 0.6 W.

### Comparative Example 1

A waveform groove, an intermediate groove and a shoulder groove are present on a tread surface. The long portion of the intermediate groove has an angle θ of 30 degrees. The region of the intermediate groove is 0.15 W to 0.6 W.

### Comparative Example 2

A waveform groove, an intermediate groove and a shoulder groove are present on a tread surface. The long portion of the intermediate groove has an angle θ of 55 degrees. The region of the intermediate groove is 0 W to 0.15 W.

### Comparative Example 3

A waveform groove, an intermediate groove and a shoulder groove are present on a tread surface. The long portion of the intermediate groove has an angle θ of 55 degrees. The region of the intermediate groove is 0.6 W to 1 W.

### Comparative Example 4

A waveform groove, an intermediate groove and a shoulder groove are present on a tread surface. The long portion of the intermediate groove has an angle θ of 80 degrees. The region of the intermediate groove is 0.15 W to 0.6 W.

In the second comparison test, the tread pattern of the tire according to each of the examples and the comparative examples is as follows.

### Example 1

A waveform groove, an intermediate groove and a shoulder groove are present on a tread surface. The long portion of the intermediate groove has an angle θ of 55 degrees. The region of the intermediate groove is 0.15 W to 0.6 W. The shoulder groove has an angle α of 25 degrees (α<θ).

### Example 2

A waveform groove, an intermediate groove and a shoulder groove are present on a tread surface. The long portion of the intermediate groove has an angle θ of 55 degrees. The region of the intermediate groove is 0.15 W to 0.6 W. The shoulder groove has an angle α of 30 degrees (α<θ).

### Example 3

A waveform groove, an intermediate groove and a shoulder groove are present on a tread surface. The long portion of the intermediate groove has an angle θ of 55 degrees. The region of the intermediate groove is 0.15 W to 0.6 W. The shoulder groove has an angle α of 40 degrees (α<θ).

### Example 4

A waveform groove, an intermediate groove and a shoulder groove are present on a tread surface. The long portion of the intermediate groove has an angle θ of 55 degrees. The region of the intermediate groove is 0.15 W to 0.6 W. The shoulder groove has an angle α of 50 degrees (α<0).

### Comparative Example 1

A waveform groove, an intermediate groove and a shoulder groove are present on a tread surface. The long portion of the intermediate groove has an angle θ of 55 degrees. The region of the intermediate groove is 0.15 W to 0.6 W. The shoulder groove has an angle α of 20 degrees (α<0).

### Comparative Example 2

A waveform groove, an intermediate groove and a shoulder groove are present on a tread surface. The long portion of the intermediate groove has an angle θ of 55 degrees. The region of the intermediate groove is 0.15 W to 0.6 W. The shoulder groove has an angle α of 55 degrees (α=0).

### Comparative Example 3

A waveform groove, an intermediate groove and a shoulder groove are present on a tread surface. The long portion of the intermediate groove has an angle θ of 45 degrees. The region of the intermediate groove is 0.15 W to 0.6 W. The shoulder groove has an angle α of 45 degrees (a=0).

### Comparative Example 4

A waveform groove, an intermediate groove and a shoulder groove are present on a tread surface. The long portion of the intermediate groove has an angle θ of 45 degrees. The region of the intermediate groove is 0.15 W to 0.6 W. The shoulder groove has an angle α of 50 degrees (α>θ).

### Comparative Example 5

A waveform groove, an intermediate groove and a shoulder groove are present on a tread surface. The long portion of the intermediate groove has an angle θ of 45 degrees. The region of the intermediate groove is 0.15 W to 0.6 W. The shoulder groove has an angle α of 55 degrees (α>θ)

TABLE 1

| | Comparative | | Comparative | | Comparative | | | Comparative |
|---|---|---|---|---|---|---|---|---|
| | Example 1 | Example 1 | Example 2 | Example 2 | Example 3 | Example 3 | Example 4 | Example 4 |
| Angle θ (deg) | 30 | 45 | 55 | 55 | 55 | 65 | 75 | 80 |
| Intermediate | 0.15 W˜ | 0.15 W˜ | 0 W˜ | 0.15 W˜ | 0.6 W˜ | 0.15 W˜ | 0.15 W˜ | 0.15 W˜ |
| groove | 0.6 W | 0.6 W | 0.15 W | 0.6 W | 1 W | 0.6 W | 0.6 W | 0.6 W |
| region | | | | | | | | |
| Noise | C | A | C | A | A | A | A | A |
| feeling in | | | | | | | | |
| straight | | | | | | | | |
| running | | | | | | | | |
| Noise | C | A | A | A | B | A | A | A |
| feeling in | | | | | | | | |
| cornering | | | | | | | | |
| Handling | B | A | B | A | C | A | A | C |
| stability | | | | | | | | |

TABLE 2

| | Comparative | | | | | Comparative | Comparative | Comparative | Comparative |
|---|---|---|---|---|---|---|---|---|---|
| | Example 1 | Example 1 | Example 2 | Example 3 | Example 4 | Example 2 | Example 3 | Example 4 | Example 5 |
| Angle α | 20 | 25 | 30 | 40 | 50 | 55 | 45 | 50 | 55 |
| (deg) | (α < θ) | (α < θ) | (α < θ) | (α < θ) | (α < θ) | (α = θ) | (α = θ) | (α > θ) | (α > θ) |
| Angle θ | 55 | 55 | 55 | 55 | 55 | 55 | 45 | 45 | 45 |
| (deg) | | | | | | | | | |
| Intermediate | 0.15 W˜ | 0.15 W˜ | 0.15 W˜ | 0.15 W˜ | 0.15 W˜ | 0.15 W˜ | 0.15 W˜ | 0.15 W˜ | 0.15 W˜ |
| groove | 0.6 W | 0.6 W | 0.6 W | 0.6 W | 0.6 W | 0.6 W | 0.6 W | 0.6 W | 0.6 W |
| region | | | | | | | | | |
| Noise feeling | C | A | A | A | A | B | B | B | B |
| in cornering | | | | | | | | | |

As shown in the Table 1, in the case in which the motorcycle carries out ordinary cornering, the angle θ of the intermediate groove is set to be 45 to 75 degrees and the intermediate groove is provided in the region of 0.15 W to 0.6 W. Consequently, an excellent noise feeling can be obtained, and furthermore, an excellent handling stability can be obtained. As shown in the Table 2, moreover, in the case in which the motorcycle carries out the high speed cornering, the angle α of the shoulder groove is set to be 25 to 50 degrees and the condition of α<θ is satisfied. Consequently, an excellent noise feeling can be obtained.

1. A tire for a rear wheel of a motorcycle having a single waveform groove provided in a circumferential direction on a center of a tread surface, and a plurality of intermediate grooves arranged regularly side by side along the waveform groove outward in an axial direction of the waveform groove,
wherein each of the intermediate grooves takes a shape of a boomerang having a short portion extended outward in an axial direction to gradually go away from the waveform groove, and a long portion linked continuously to the short portion and extended inward in the axial direction to gradually approach the waveform groove, and crossing at an angle (45 degrees≦θ≦75 degrees) with respect to the axial direction, and is provided in a region of 0.15 W to 0.6 W on the basis of the center of the tread surface with respect to a tread width W.

2. The tire for a rear wheel of a motorcycle according to claim 1, further comprising a plurality of shoulder grooves arranged regularly side by side in the circumferential direction outward in the axial direction of the intermediate groove,
each of the shoulder grooves being extended in a direction as that to cross at an angle α (25 degrees≦α≦50 degrees) with respect to the axial direction and being set to be the angle α< the angle θ.
